(19) United States
(12) Patent Application Publication
(10) Pub. No.: US 2022/0270252 A1
(43) Pub. Date: Aug. 25, 2022

(54) Automated System And Method For Detecting Plant Disease And Providing Disease Treatment Solution

(71) Applicants: Nuzhat Faiz Shaikh, Pune (IN); Ayes Chinmay, Bhubaneswar (IN); Mahmoud Ragab, Jeddah (SA); Abdullah S. AL-Malaise AL-Ghamdi, Jeddah (SA); Adnen EL AMRAOUI, Béthune (FR); Romany F. Mansour, El-Kharga (EG); Kishor H. Walse, Chikhli (IN); Amol S. Kamble, Pune (IN); Bhagyashri Fakira More, Pune (IN); Yashwant S. Ingle, Pune (IN)

(72) Inventors: Nuzhat Faiz Shaikh, Pune (IN); Ayes Chinmay, Bhubaneswar (IN); Mahmoud Ragab, Jeddah (SA); Abdullah S. AL-Malaise AL-Ghamdi, Jeddah (SA); Adnen EL AMRAOUI, Béthune (FR); Romany F. Mansour, El-Kharga (EG); Kishor H. Walse, Chikhli (IN); Amol S. Kamble, Pune (IN); Bhagyashri Fakira More, Pune (IN); Yashwant S. Ingle, Pune (IN)

(21) Appl. No.: 17/684,687

(22) Filed: Mar. 2, 2022

(51) Int. Cl. G06T 7/00; G06V 20/10; G06V 10/82

(52) U.S. Cl. CPC G06T 7/0012; G06V 20/188; G06V 10/82; G06T 2207/20081; G06T 2207/20084; G06T 2207/30188

(57) ABSTRACT

The present invention generally relates to a plant disease detection system comprises an acquisition unit for collecting pictures of sick and sound plant leaves gathered under controlled conditions from a public dataset; a training unit for training a convolutional neural network technique-based model to distinguish harvest species and sicknesses; a camera for capturing real time image of a plant; a central processing unit for estimating weight file (BMI) and muscle versus fat ratio status (BF %) utilizing bio impedance in order to detect disease of the plant, wherein the weight file (BMI) and muscle versus fat ratio status (BF %) is estimated upon comparing real time image of the plant with pictures of sick and sound plant leaves gathered under controlled conditions; and an alert unit for transferring an alert signal of the detected disease and its stage on a user computing device.

### FIELD OF THE INVENTION

The present disclosure relates to an automated system and method for detecting plant disease and providing disease treatment solution.

### BACKGROUND OF THE INVENTION

The development of herbicide-tolerant crops allows for increased usage of post-emergent herbicides during crop cultivation. N-phosphonomethylglycine, often known as glyphosate, is an example of a post-emergent herbicide with action on a wide range of plant species. Glyphosate is the active component of Roundup, a safe herbicide with a desirable short environmental half-life. When glyphosate is sprayed to a plant surface, it travels systemically through the plant. Glyphosate is hazardous to plants because it inhibits an enzyme in the shikimic acid pathway, which is a precursor for the production of aromatic amino acids. The 5-enolpyruvylshikimate-3-phosphate synthase (EPSPS) enzyme is found in plants, fungi, and certain bacteria and is vulnerable to the harmful effects of glyphosate.

Typically, farmers rely on genetic resistance to safeguard their crops against plant pathogen infection and disease. However, adequate genetic resistance is not always present in the crops being grown, or undesired features are connected to the genetic resistant loci. Farmers must subsequently use pesticides to control the pathogen infections, which considerably raises the cost of agricultural production and has a negative impact on the environment.

However, it has been observed that the crops get destroyed due to unawareness of crop disease and specific medicine and its treatment method even after sprinkling the pesticides. In the view of the forgoing discussion, it is clearly portrayed that there is a need to have an automated system and method for detecting plant disease and providing disease treatment solution.

### SUMMARY OF THE INVENTION

The present disclosure seeks to provide a system and method for detecting plant disease and providing the treatment solution of the disease to produce good yield.

In an embodiment, an automated system for detecting plant disease and providing disease treatment solution is disclosed. The system includes an acquisition unit for collecting pictures of sick and sound plant leaves gathered under controlled conditions from a public dataset. The system further includes a training unit for training a convolutional neural network technique-based model to distinguish harvest species and sicknesses. The system further includes a camera for capturing real time image of a plant. The system further includes a central processing unit for estimating weight file (BMI) and muscle versus fat ratio status (BF %) utilizing bio impedance in order to detect disease of the plant, wherein the weight file (BMI) and muscle versus fat ratio status (BF %) is estimated upon comparing real time image of the plant with pictures of sick and sound plant leaves gathered under controlled conditions. The system further includes an alert unit for transferring an alert signal of the detected disease and its stage on a user computing device.

In one embodiment, the convolutional neural network technique-based model is engaged with the central processing unit to examine a set of pictures of plant leaves having a spread of a plurality of class marks relegated to them, wherein each class mark is a harvest infection pair to make an endeavor to foresee the yield sickness pair given simply the picture of the plant leaf.

In one embodiment, the system comprises a pre-processing unit to resize the pictures to a predetermined pixels in order to perform both the model optimization and forecast on the downscaled pictures.

In one embodiment, the system comprises a communication module to transfer the alert signal to the user computing device.

In one embodiment, the system comprises a feature extraction unit to extract features of the sick and sound plant leaves picture to train the convolutional neural network technique-based model and to extract the feature of the real time image of the plant.

In one embodiment, the extracted features of the sick and sound plant leaves picture and the feature of the real time image of the plant are stored in a cloud server such that the central processing unit is allowed to access the extracted features wirelessly during plant disease detection.

In another embodiment, a method for plant disease detection is disclosed. The method includes collecting pictures of sick and sound plant leaves gathered under controlled conditions from a public dataset. The method further includes pre-processing pictures of sick and sound plant leaves thereby extracting features. The method further includes training a convolutional neural network technique-based model using extracted features to distinguish harvest species and sicknesses. The method further includes capturing real time image of a plant and extracting its features. The method further includes estimating weight file (BMI) and muscle versus fat ratio status (BF %) utilizing bio impedance in order to detect disease of the plant, wherein the weight file (BMI) and muscle versus fat ratio status (BF %) is estimated upon comparing features of the real time image of the plant with pictures of sick and sound plant leaves. The method further includes transferring an alert signal of the detected disease and its stage on a user computing device.

In one embodiment, the convolutional neural network technique-based model is trained to assist a crop care routine and a user defined medicine and its usage to treat the disease of the plant.

In one embodiment, the crop care routine comprises irrigation timing and irrigation pattern, pesticide sprinkling quantity and its pattern, and a type of medicine along with its name according to the type of the crop, disease and stage of the disease.

In one embodiment, the convolutional neural network technique-based model is trained with the detected disease and its type by the training unit to optimize the convolutional neural network technique-based model for minimizing its response time and reducing possible error in disease detection.

An object of the present disclosure is to detect plant disease and provide the treatment solution of the disease.

Another object of the present disclosure is to improve crop production and quality of the crop.

Yet another object of the present invention is to deliver an expeditious and cost-effective system for detecting plant disease and providing disease treatment solution.

To further clarify advantages and features of the present disclosure, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF FIGURES

These and other features, aspects, and advantages of the present disclosure will become better understood when the following detailed description is read with reference to the accompanying drawings in which like characters represent like parts throughout the drawings, wherein:

FIG. 1 illustrates a block diagram of an automated system for detecting plant disease and providing disease treatment solution in accordance with an embodiment of the present disclosure; and

FIG. 2 illustrates a flow chart of an automated method for detecting plant disease and providing disease treatment solution in accordance with an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying drawings.

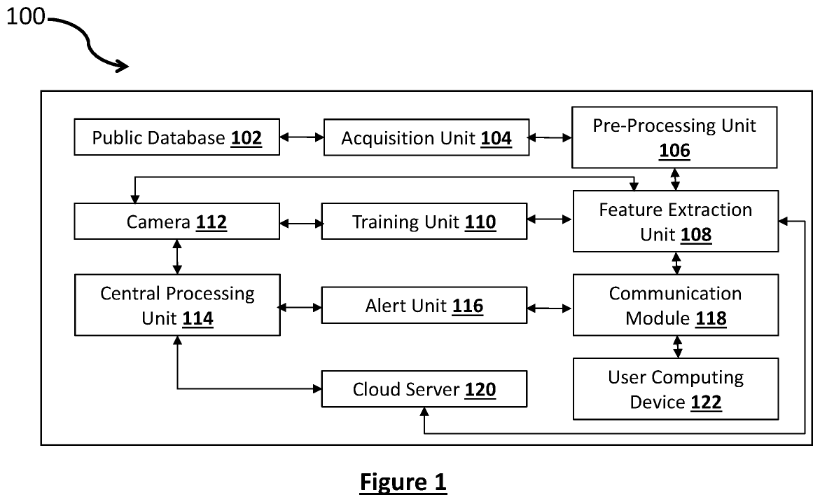

Referring to FIG. 1, a block diagram of an automated system for detecting plant disease and providing disease treatment solution is illustrated in accordance with an embodiment of the present disclosure. The system 100 includes an acquisition unit 104 for collecting pictures of sick and sound plant leaves gathered under controlled conditions from a public dataset 102.

In an embodiment, a training unit 110 is connected to the acquisition unit 104 for training a convolutional neural network technique-based model to distinguish harvest species and sicknesses.

In an embodiment, a camera 112 is employed for capturing real time image of a plant, wherein a cellphone camera 112 can be used to capture real time image of the plant.

In an embodiment, a central processing unit 114 is interconnected to the camera 112 and acquisition unit 104 for estimating weight file (BMI) and muscle versus fat ratio status (BF %) utilizing bio impedance in order to detect disease of the plant, wherein the weight file (BMI) and muscle versus fat ratio status (BF %) is estimated upon comparing real time image of the plant with pictures of sick and sound plant leaves gathered under controlled conditions.

In an embodiment, an alert unit 116 is connected to the central processing unit 114 for transferring an alert signal of the detected disease and its stage on a user computing device 122.

In one embodiment, the convolutional neural network technique-based model is engaged with the central processing unit 114 to examine a set of pictures of plant leaves having a spread of a plurality of class marks relegated to them, wherein each class mark is a harvest infection pair to make an endeavor to foresee the yield sickness pair given simply the picture of the plant leaf.

In one embodiment, the system comprises a pre-processing unit 106 connected to the acquisition unit 104 to resize the pictures to a predetermined pixels in order to perform both the model optimization and forecast on the downscaled pictures.

In one embodiment, the system comprises a communication module 118 to transfer the alert signal to the user computing device 122.

In one embodiment, the system comprises a feature extraction unit 108 connected to the pre-processing unit 106 to extract features of the sick and sound plant leaves picture to train the convolutional neural network technique-based model and to extract the feature of the real time image of the plant.

In one embodiment, the extracted features of the sick and sound plant leaves picture and the feature of the real time image of the plant are stored in a cloud server 120 such that the central processing unit 114 is allowed to access the extracted features wirelessly during plant disease detection.

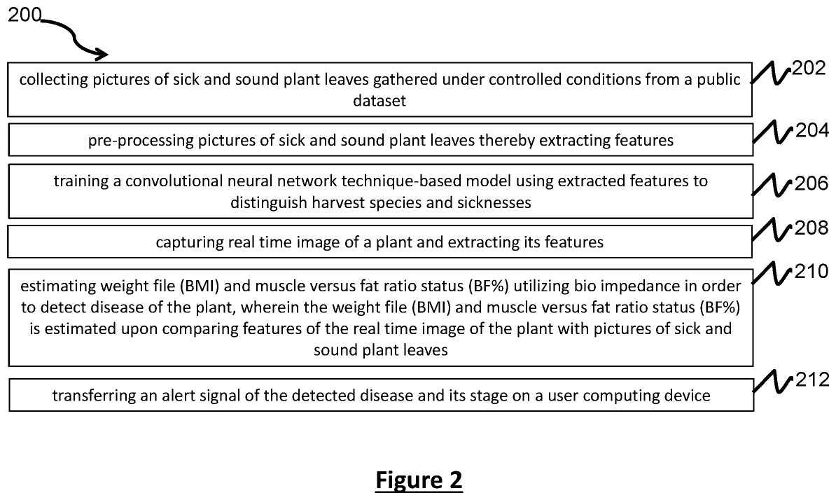

FIG. 2 illustrates a flow chart of an automated method for detecting plant disease and providing disease treatment solution in accordance with an embodiment of the present disclosure. At step 202, the method 200 includes collecting pictures of sick and sound plant leaves gathered under controlled conditions from a public dataset 102.

At step 204, the method 200 includes pre-processing pictures of sick and sound plant leaves thereby extracting features.

At step 206, the method 200 includes training a convolutional neural network technique-based model using extracted features to distinguish harvest species and sicknesses.

At step 208, the method 200 includes capturing real time image of a plant and extracting its features.

At step 210, the method 200 includes estimating weight file (BMI) and muscle versus fat ratio status (BF %) utilizing bio impedance in order to detect disease of the plant, wherein the weight file (BMI) and muscle versus fat ratio status (BF %) is estimated upon comparing features of the real time image of the plant with pictures of sick and sound plant leaves.

At step 212, the method 200 includes transferring an alert signal of the detected disease and its stage on a user computing device 122.

In one embodiment, the convolutional neural network technique-based model is trained to assist a crop care routine and a user defined medicine and its usage to treat the disease of the plant.

In one embodiment, the crop care routine comprises irrigation timing and irrigation pattern, pesticide sprinkling quantity and its pattern, and a type of medicine along with its name according to the type of the crop, disease and stage of the disease.

In one embodiment, the convolutional neural network technique-based model is trained with the detected disease and its type by the training unit 110 to optimize the convolutional neural network technique-based model for minimizing its response time and reducing possible error in disease detection.

In an exemplary embodiment, 54,306 pictures of plant leaves are examined, which have a spread of 38 class marks relegated to them. Each class mark is a harvest infection pair, and an endeavor is made to foresee the yield sickness pair given simply the picture of the plant leaf. In every one of the methodologies depicted in this invention, the pictures are resized to 256×256 pixels, and both the model improvement and forecasts on these downscaled pictures are performed.

Across the entirety of our examinations, three unique variants of the entire Plant-Village dataset is utilized. Initially, start with the Plant-Village dataset all things considered, in shading; then, at that point, explore different avenues regarding a dark scaled form of the Plant-Village dataset, lastly run every one of the tests on a variant of the Plant-Village dataset where the leaves are fragmented, consequently eliminating all the additional foundation data which may can possibly present some inborn inclination in the dataset because of the regularized course of information assortment if there should be an occurrence of Plant-Village dataset.

Division is robotized by the method for a content tuned to perform well on our specific dataset. A method dependent on a bunch of covers produced by examination of the shading, delicacy and immersion parts of various pieces of the pictures in a few shading spaces (Lab and HSB) are picked. One of the means of that handling additionally permitted us to effectively fix shading projects, which turned out to be exceptionally solid in a portion of the subsets of the dataset, along these lines eliminating another possible inclination.

This arrangement of examinations is intended to comprehend on the off chance that the neural organization really learns the “thought” of plant infections, or then again assuming it is simply learning the intrinsic predispositions in the dataset.

Cell phones specifically offer exceptionally clever ways to deal with assistance recognize illnesses as a result of their figuring power, high-goal shows, and broad implicit arrangements of adornments, for example, progressed HD cameras 112. It is broadly assessed that there will be somewhere in the range of 5 and 6 billion cell phones on the globe by 2020. Toward the finish of 2015, currently 69% of the total populace approached portable broadband inclusion, and versatile broadband infiltration arrived at 47% in 2015, a 12-overlap increment beginning around 2007. The joined elements of broad cell phone entrance, HD cameras 112, and superior execution processors in cell phones lead to a circumstance where infection determination dependent on robotized picture acknowledgment, if in fact achievable, can be made accessible at a phenomenal scale. Here, the specialized plausibility utilizing a profound learning approach is exhibited using 54,306 pictures of 14 yield species with 26 illnesses (or solid) made transparently accessible through the undertaking Plant-Village. An illustration of each harvest.

The three forms of the dataset (shading, dark scale, and sectioned) show a trademark variety in execution across every one of the examinations when the remainder of the exploratory design consistent is kept. The models play out the most incredible if there should arise an occurrence of the hued variant of the dataset. When planning the investigations, everyone is worried that the neural organizations may just figure out how to get the innate predispositions related with the lighting conditions, the technique and contraption of assortment of the information. Accordingly, system tried different things with the dark scaled form of the equivalent dataset to test the model's versatility without even a trace of shading data, and its capacity to learn more elevated level primary examples normal to specific yields and sicknesses and also True to form, the presentation diminished when contrasted with the investigations on the shaded adaptation of the dataset, yet even on account of the most noticeably terrible exhibition, the noticed mean Fl score is 0.8524 (by and large precision of 85.53%).

The fragmented forms of the entire dataset is additionally ready to research the job of the foundation of the pictures in generally speaking execution, the exhibition of the model utilizing divided pictures is reliably better compared to that of the model utilizing dark scaled pictures, however somewhat lower than that of the model utilizing the hued adaptation of the pictures. While these methodologies yield great outcomes on the Plant-Village dataset which is gathered in a controlled climate, likewise survey is performed of the model's exhibition on pictures tested from confided in web-based sources, for example, scholastic farming augmentation administrations. Such pictures are not accessible on a huge scale, and utilizing a blend of computerized download from Bing Image Search and IPM Images with a visual check step, system got two little, confirmed datasets of 121 (dataset 1) and 119 pictures (dataset 2), separately (see Supplementary Material for a point-by-point depiction of the interaction).

Utilizing the best model on these datasets, a general precision of 31.40% in dataset 1, and 31.69% in dataset 2, in effectively anticipating the right class mark (i.e., yield and infection data) from among 38 potential class names is achieved. It has been noted that an arbitrary classifier will get a normal precision of just 2.63%. Across all pictures, the right class is in the main 5 forecasts in 52.89% of the cases in dataset 1, and in 65.61% of the cases in dataset 2. The best models for the two datasets were.

The developed system facilitates in detecting crop disease and providing its treatment solution using machine learning approach. The blend of expanding worldwide cell phone entrance and ongoing advances in PC vision made conceivable by profound learning has made ready for cell phone helped infection determination. Utilizing a public dataset 102 of 54,306 pictures of sick and sound plant leaves gathered under controlled conditions, a profound convolutional neural organization is trained to distinguish 14 harvest species and 26 sicknesses (or nonappearance thereof). The prepared model accomplishes an exactness of 99.35% on a held-out test set, showing the achievability of this methodology. Generally, the methodology of preparing profound learning models on progressively huge and freely accessible picture datasets presents a make way toward cell phone helped crop illness determination on an enormous worldwide scale. The weight file (BMI) and muscle versus fat ratio status (BF %) is evaluated utilizing bio impedance. Way of life status is acquired by normalized electronic surveys. For assessing the intentions in after severe PBD, the members are approached to rank 8 distinct thought processes (i.e., 8: the most-, 1: the most un-significant). Setting. A cross-sectional review in Slovenia. Members. An aggregate of 151 solid grown-ups with a normal period of 39.6 years (SD: 12.5 years). Results. The members had a normal BMI of 23.9 kg/m2 (SD: 3.8 kg/m2) and a normal BF % of 22.3% (SD: 7.3%), are truly extremely dynamic, with a normal Long International Physical Activity Questionnaire (L-IPAQ) score of 5541.2 metabolic counterparts (METs) min/week (SD: 4677.0 METs min/week), having great rest quality, with a normal Pittsburgh Sleep Quality Index (PSQI) score of 2.7 (SD: 1.8), seeing low pressure, and with a normal Perceived Stress Questionnaire (PSQ) score of 0.29 (SD: 0.1) and also found no critical contrasts in way of life between members who are engaged with our WFPB way of life program for short, medium, or significant stretches of time. The intentions in WFPB way of life included medical advantages (score: 7.9/8), weight the board (6.3), eating to satiety (4.9), accommodation (4.3), ecological worries (4.1), moderateness (3.7), creature morals (3.6), and strict reasons (1.1). End. A WFPB way of life program for any timeframe that incorporates a broad emotionally supportive network gives good, long-haul way of life changes.

The objective of the invention is to provide a “PHP-Observation: Plant Based Health Products, Scientific Validation using ML-Based Observation” is a Crop illnesses are a significant danger to food security, yet their fast ID stays troublesome in many regions of the planet because of the absence of the essential foundation.

The other objective of the invention is to provide a blend of expanding worldwide cell phone entrance and ongoing advances in PC vision made conceivable by profound learning has made ready for cell phone helped infection determination. Utilizing a public dataset 102 of 54,306 pictures of sick and sound plant leaves gathered under controlled conditions, a profound convolutional neural organization is trained to distinguish 14 harvest species and 26 sicknesses (or nonappearance thereof).

The other objective of the invention is to provide a prepared model accomplish an exactness of 99.35% on a held-out test set, showing the achievability of this methodology. Generally, the methodology of preparing profound learning models on progressively huge and freely accessible picture datasets presents a make way toward cell phone helped crop illness determination on an enormous worldwide scale.

The other objective of the invention is to provide an estimated weight file (BMI) and muscle versus fat ratio status (BF %) utilizing bio impedance. Way of life status is acquired by normalized electronic surveys. For assessing the intentions in after severe PBD, the members are approached to rank 8 distinct thought processes (i.e., 8: the most-, 1: the most un-significant). Setting. A cross-sectional review in Slovenia. Members.

The other objective of the invention is to provide an aggregate of 151 solid grown-ups with a normal period of 39.6 years (SD: 12.5 years). Results. The members had a normal BMI of 23.9 kg/m2 (SD: 3.8 kg/m2) and a normal BF % of 22.3% (SD: 7.3%), are truly extremely dynamic, with a normal Long International Physical Activity Questionnaire (L-IPAQ) score of 5541.2 metabolic counterparts (METs) min/week (SD: 4677.0 METs min/week), having great rest quality.

The other objective of the invention is to provide a Pittsburgh Sleep Quality Index (PSQI) score of 2.7 (SD: 1.8), seeing low pressure, and with a normal Perceived Stress Questionnaire (PSQ) score of 0.29 (SD: 0.1) and also found no critical contrasts in way of life between members who are engaged with our WFPB way of life program for short, medium, or significant stretches of time

The other objective of the invention is to provide a WFPB way of life included medical advantages (score: 7.9/8), weight the board (6.3), eating to satiety (4.9), accommodation (4.3), ecological worries (4.1), moderateness (3.7), creature morals (3.6), and strict reasons (1.1). End. A WFPB way of life program for any timeframe that incorporates a broad emotionally supportive network gives good, long-haul way of life changes.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A plant disease detection system, the system comprises:
an acquisition unit for collecting pictures of sick and sound plant leaves gathered under controlled conditions from a public dataset;
a training unit for training a convolutional neural network technique-based model to distinguish harvest species and sicknesses;
a camera for capturing real time image of a plant;
a central processing unit for estimating weight file (BMI) and muscle versus fat ratio status (BF %) utilizing bio impedance in order to detect disease of the plant, wherein the weight file (BMI) and muscle versus fat ratio status (BF %) is estimated upon comparing real time image of the plant with pictures of sick and sound plant leaves gathered under controlled conditions; and
an alert unit for transferring an alert signal of the detected disease and its stage on a user computing device.

2. The system of claim 1, wherein the convolutional neural network technique-based model is engaged with the central processing unit to examine a set of pictures of plant leaves having a spread of a plurality of class marks relegated to them, wherein each class mark is a harvest infection pair to make an endeavour to foresee the yield sickness pair given simply the picture of the plant leaf.

3. The system of claim 1, wherein said system comprises a pre-processing unit to resize the pictures to a predetermined pixels in order to perform both the model optimization and forecast on the downscaled pictures.

4. The system of claim 1, wherein said system comprises a communication module to transfer the alert signal to the user computing device.

5. The system of claim 1, wherein said system comprises a feature extraction unit to extract features of the sick and sound plant leaves picture to train the convolutional neural network technique-based model and to extract the feature of the real time image of the plant.

6. The system of claim 5, wherein the extracted features of the sick and sound plant leaves picture and the feature of the real time image of the plant are stored in a cloud server such that the central processing unit is allowed to access the extracted features wirelessly during plant disease detection.

7. A method for plant disease detection, the method comprises:
collecting pictures of sick and sound plant leaves gathered under controlled conditions from a public dataset;
pre-processing pictures of sick and sound plant leaves thereby extracting features;
training a convolutional neural network technique-based model using extracted features to distinguish harvest species and sicknesses;
capturing real time image of a plant and extracting its features;
estimating weight file (BMI) and muscle versus fat ratio status (BF %) utilizing bio impedance in order to detect disease of the plant, wherein the weight file (BMI) and muscle versus fat ratio status (BF %) is estimated upon comparing features of the real time image of the plant with pictures of sick and sound plant leaves; and
transferring an alert signal of the detected disease and its stage on a user computing device.

8. The method of claim 7, wherein the convolutional neural network technique-based model is trained to assist a crop care routine and a user defined medicine and its usage to treat the disease of the plant.

9. The method of claim 8, wherein the crop care routine comprises irrigation timing and irrigation pattern, pesticide sprinkling quantity and its pattern, and a type of medicine along with its name according to the type of the crop, disease and stage of the disease.

10. The method of claim 7, wherein the convolutional neural network technique-based model is trained with the detected disease and its type by the training unit to optimize the convolutional neural network technique-based model for minimizing its response time and reducing possible error in disease detection.
